(19) United States
(12) Patent Application Publication
(10) Pub. No.: US 2011/0014405 A1
(43) Pub. Date: Jan. 20, 2011

(54) HOUSING AND METHOD FOR MAKING THE HOUSING

(75) Inventors: HONG-BO LI, Shenzhen City (CN); YAN-MIN WANG, Shenzhen City (CN); GANG HUANG, Shenzhen City (CN)

Correspondence Address: Altis Law Group, Inc.;ATTN: Steven Reiss, 288 SOUTH MAYO AVENUE, CITY OF INDUSTRY, CA, 91789, US

(73) Assignees: SHENZHEN FUTAIHONG PRECISION INDUSTRY CO., LTD., ShenZhen City (CN); FIH (HONG KONG) LIMITED, Kowloon (HK)

(21) Appl. No.: 12/575,864

(22) Filed: Oct. 8, 2009

(30) Foreign Application Priority Data
Jul. 14, 2009 (CN) 200910304332.8

(51) Int. Cl. B32B 1/02; B29C 65/00

(52) U.S. Cl. 428/35.9; 264/132; 428/35.7

(57) ABSTRACT

A method for making a housing, comprising the steps of: providing a plastic film, the plastic film having an outer surface and an inner surface; forming a paint layer on the outer surface of the plastic film, the paint layer having a soft tactility; forming a decorative layer on the inner surface of the plastic film; forming a nonconductive metallic layer on the decorative layer; forming a protective layer on the nonconductive layer; and molding a substrate to bond the protective layer of the plastic film. A housing for electronic device made by the method is also described.

### BACKGROUND

1. Technical field

The present disclosure relates to methods for making housings having a metallic appearance and a soft tactility of electronic devices and housings made by the same.

2. Description of related art

Electronic devices often apply decorative housings to attract consumers. Housings molded from plastic materials are usually electroplated with a metallic coating to create an attractive metallic appearance. However, electroplating creates wastewater. Moreover, the electroplated metallic coating may have only a rigid tactility.

Another method for forming a metallic coating on a plastic article is to spray paint the plastic article with a metallic paint. However, the metallic paint cannot present a real metallic appearance.

Therefore, there is room for improvement within the art.

### BRIEF DESCRIPTION OF THE DRAWINGS

Many aspects of the housing and method for fabricating the housing can be better understood with reference to the following drawings. The components in the drawings are not necessarily to scale, the emphasis instead being placed upon clearly illustrating the principles of the present method for making the housing and housing made by the same. Moreover, in the drawing, like reference numerals designate corresponding parts throughout the following view.

FIG. 1 is a flow chart to explain an exemplary process for making the housing.

FIG. 2 is a cross-section view of an exemplary embodiment of the present housing.

### DETAILED DESCRIPTION OF THE EXEMPLARY EMBODIMENT

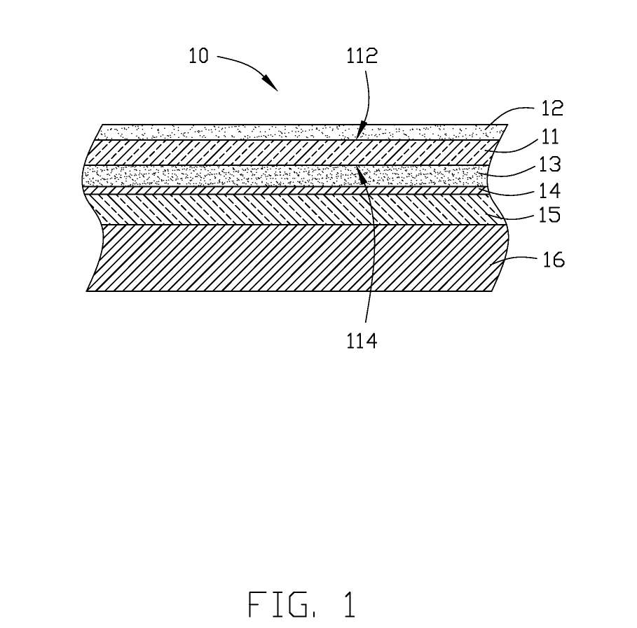

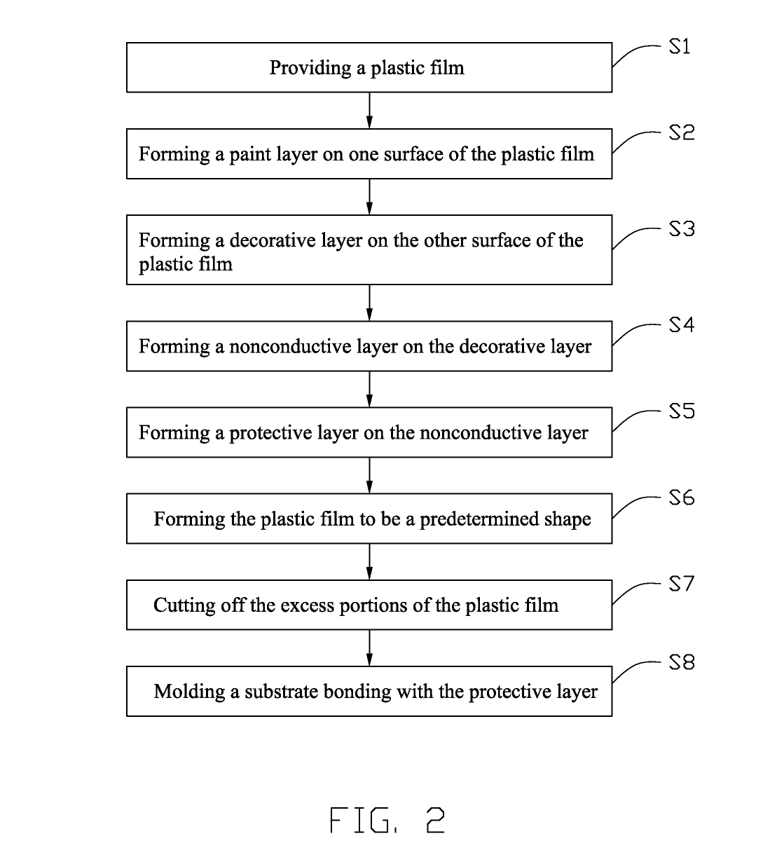

FIG. 1 shows an exemplary method for making the housing 10 (as shown in FIG. 2), which may include the following steps.

In step S1, a transparent plastic film 11 is provided. The plastic film 11 may be made of, e.g., polypropylene (PP), polymethyl methacrylate (PMMA), polyvinyl chloride (PVC), or polycarbonate (PC). The plastic film 11 has an outer surface 112 and an inner surface 114.

In step S2, a paint layer 12 is formed on the outer surface 112 of the plastic film 11 for example, by spray painting. The paint layer 12 is made of a paint having a soft tactility such as acrylic lacquer, or polyurethane lacquer.

In step S3, a decorative layer 13 is formed on the inner surface 114 of the plastic film 11 such as by printing. The decorative layer 13 may be screen printed by colorized ink having a degree of transparency (i.e., non-opaque).

In step S4, a nonconductive metallic layer 14 having a metallic appearance is formed on the decorative layer 13 by implementing a vacuum coating method such as vacuum evaporating or vacuum sputtering. The nonconductive metallic layer 14 may be made of one or more materials selected from a group consisting of indium, aluminum, titanium, tin, chromium, aurum, vanadium, stainless steel and indium-tin alloy. The nonconductive metallic layer 14 may have a degree of transparency (i.e., non-opaque).

In step S5, a protective layer 15 is formed on the nonconductive metallic layer 14. The protective layer 15 may be a transparent ink layer printed, for example, by screen printing. The protective layer 15 may be a UV curable ink layer which can be formed by repeatedly printing and UV curing to ensure a good resistance of erosion and abrasion. The protective layer 15 may have a high rigidity, and thus protect the nonconductive metallic layer 14 from being damaged in the following insert molding.

In step S6, the preformed plastic film 11 is processed to achieve a predetermined shape, for example by vacuum forming, pressure forming, or thermal forming. Accordingly, the plastic film has a three-dimensional shape corresponding to the housing 10.

In step S7, the excess portions of the plastic film 11 beyond the predetermined shape are cut off by laser cutting or machine cutting.

In step S8, a substrate 16 is formed by insert molding. This step is carried out by inserting the plastic film 11 into an injection mold. A plastic material is injected into the injection mold to form the substrate 16 bonding with protective layer 15 of the plastic film 11. Accordingly, the housing 10 is formed.

The achieved housing 10 includes the transparent plastic film 11, the paint layer 12 formed on the outer surface 112 of the plastic film 11, the decorative layer 13 formed on the inner surface 114, the nonconductive metallic layer 14 formed on the decorative layer 13, the protective layer 15 formed on the nonconductive metallic layer 14, and the substrate 16 bonding the protective layer 15. The paint layer 12 has a soft tactility. The decorative layer 13 is made of a transparent or semitransparent colorized ink. The protective layer 15 is made of transparent UV curable paint.

It should be understood, however, that even though numerous characteristics and advantages of the present embodiments have been set forth in the foregoing description, together with details of the structures and functions of the embodiments, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A method for making a housing, comprising the steps of:
providing a plastic film, the plastic film having an outer surface and an inner surface;
forming a paint layer on the outer surface of the plastic film, the paint layer having a soft tactility;
forming a decorative layer on the inner surface of the plastic film;
forming a nonconductive metallic layer on the decorative layer;
forming a protective layer on the nonconductive layer; and
molding a substrate to bond the protective layer of the plastic film.

2. The method for making a housing as claimed in claim 1, wherein the plastic film having a degree of transparency.

3. The method for making a housing as claimed in claim 1, wherein the nonconductive metallic layer is formed by vacuum evaporating or vacuum sputtering.

4. The method for making a housing as claimed in claim 3, wherein the nonconductive metallic layer is made of one or more materials selected from a group consisting of indium, aluminum, titanium, tin, chromium, aurum, vanadium, stainless steel and indium-tin alloy.

5. The method for making a housing as claimed in claim 1, wherein the decorative layer is screen printed by colorized ink having a degree of transparency.

6. The method for making a housing as claimed in claim 1, wherein the protective layer is screen printed by transparent ink.

7. The method for making a housing as claimed in claim 1, further comprising forming the plastic film to be a predetermined shape and cutting off the excess portions of the plastic film beyond the predetermined shape before the molding of the substrate.

8. The method for making a housing as claimed in claim 1, wherein the paint layer is made of acrylic lacquer or polyurethane lacquer.

9. The method for making a housing as claimed in claim 1, wherein the plastic film is made of plastic selected from a group consisting of polypropylene, polymethyl methacrylate, polyvinyl chloride, or polycarbonate.

10. A housing, comprising:
a plastic film, the plastic film having an outer surface and an inner surface;
a paint layer formed on the outer surface of the plastic film, the paint layer having a soft tactility;
a decorative layer formed on the inner surface of the plastic film;
a nonconductive metallic layer formed on the decorative layer;
a protective layer formed on the nonconductive metallic layer, the pattern layer having a predetermined pattern thereon; and
a molded substrate bonding the protective layer of the plastic film.

11. The housing as claimed in claim 10, wherein the plastic film having a degree of transparency.

12. The housing as claimed in claim 10, wherein the nonconductive metallic layer is made of one or more materials selected from a group consisting of indium, aluminum, titanium, tin, chromium, aurum, vanadium, stainless steel and indium-tin alloy.

13. The housing as claimed in claim 10, wherein the decorative layer is made by colorized ink having a degree of transparency.

14. The housing as claimed in claim 10, wherein the protective layer is made of transparent ink.

15. The housing as claimed in claim 10, wherein the paint layer is made of acrylic lacquer or polyurethane lacquer.

16. The housing as claimed in claim 10, wherein the plastic film is made of plastic selected from a group consisting of polypropylene, polymethyl methacrylate, polyvinyl chloride, or polycarbonate.
